(19) United States
(12) Patent Application Publication
(10) Pub. No.: US 2009/0144280 A1
(43) Pub. Date: Jun. 4, 2009

(54) Electronic multilingual business information database system

(76) Inventor: Barry Rongsheng Su, El Monte, CA (US)

Correspondence Address: DAVID AND RAYMOND PATENT FIRM, 108 N. YNEZ AVE., SUITE 128, MONTEREY PARK, CA, 91754, US

(21) Appl. No.: 11/999,382

(22) Filed: Dec. 3, 2007

(51) Int. Cl. G06F 7/08

(52) U.S. Cl. 707/7

(57) ABSTRACT

An electronic multilingual business information database system includes a language info center, a business info center, and a search interaction platform. The language info center includes a plurality of language databases for storing characters in different languages respectively and a surrogate ID generator generating a surrogate ID for each character. The business info center includes a business database for storing business information which is decomposed into one or more of the characters and is represented by the surrogate IDs. When a search request is sent to the business info center through the search interaction platform, the business info center sorts out the surrogate IDs to match with the search request, wherein a search result is generated after the surrogate IDs are converted to the respective characters in a selected language.

### BACKGROUND OF THE PRESENT INVENTION

1. Field of Invention

The present invention relates to information technology, and more particularly to an electronic multilingual business information database system which decomposes the business information into a plurality of surrogate IDs (identifications) for search process so as to minimize the size of the business database for multilingual data storage.

2. Description of Related Arts

With the advance of information technology, searching information through Internet has become part of their daily life for many people. A typical search process usually involves the submission of a search request to a search server which is linked to a particular search database, a matching of the search request with the relevant information in that search database, and production of a search result by the search server, wherein the search result is transmitted from the search server to the user's terminal and displayed by a displaying device, such as a monitor.

As a matter of fact, the majority of websites posted on Internet are in written in English. This is partly because English, being recognized international language, is widely accepted all over the world. Conventional search engines, such as “Yahoo” and “Google” are usually user-friendly and interactive so that they present little problems for daily applications.

Difficult problems however, arise when one is trying to search a local website using an English-based search engine, or indeed search engines in any other language different that of the local website. For example, using an English version “Yahoo” to search for a Chinese or a French local website (which do not written in English) is very inconvenient. In order to resolve such difficulty, some search engines incorporates translation function whereby websites in a particular local language is translated by a predetermined dictionary so that the local websites (after translation) are matched and sorted alongside with the language of the search request so as to broaden the scope of the corresponding search result.

An associated difficulty in this area is that no one can guarantee the quality of the translation so that the search result may turn out to contain a vast number of unrelated websites. The situation will be even worse when the search request is inaccurately translated. At the end of the day, it may be that the search result contains web data which is completely irrelevant.

Moreover, even though the translation per se is satisfactory in quality, the relevant websites may not be of relevance with respect to the search request. More specifically, the search engine may match the search request with the registered websites in its database and pick up those websites which have been written in foreign languages and contain the relevant search request as translated by the information center. A problem for this method is that since the search request as translated is matched word by word from the websites contained in the database, as a result, the website picked may be totally out of context and therefore, totally irrelevant to the search result.

A powerful search engine allows the user to perform the multilingual search that when the search request is input in one language, the search result will be generated in another language. For example, when the user inputs the “Auto Repair” in English as the search request, the search result can be selected to be displayed in Spanish. Accordingly, in order to perform the multilingual search, the search server must contain a plurality of language database to store the data in different languages. In other words, one of the language databases contains the data of “Auto Repair” in English, one of them contains the data of “Auto Repair” in Spanish, and so on. Therefore, if the search server allows the user to search in four different languages, the search server must contain seven different language databases. The major drawback of the above multilingual search is that the size of each of the language databases is relatively large. It is because the business information is repeatedly duplicated in different languages to be stored in the language databases. If the word “ABC Patent Firm” in English as the search request is input, the search result of “firma de la patente del ABC” in Spanish will be generated from the Spanish language database. A Chinese user may obtain the search result of “ABC [symbol] from the Chinese language database. In other words, the business information of “ABC Patent Firm” is duplicated in the language databases. When the English language database contains 15 millions of different business information, the entire language database will contains 60 millions of the business information in different languages. It is worth to mention that an advanced search server may provide more than seven different languages for business information search, the search server may contain more than 105 millions of the business information. Therefore, the entire search process will be slowed down.

### SUMMARY OF THE PRESENT INVENTION

A main object of the present invention is to provide an electronic multilingual business information database system and method, wherein the business information is decomposed into a plurality of surrogate ID for search process so as to minimize the size of the business database for multilingual data storage.

Another object of the present invention is to provide an electronic multilingual business information database system and method, wherein the business information is stored in the business database in form of the surrogate IDs such that the business information is no limited by the language thereof.

Another object of the present invention is to provide an electronic multilingual business information database system and method, wherein all the business information with the same categorization are grouped and assigned with the common surrogate IDs, such that the size of the business database will be further minimized and the searching process of the business database will be further simplified.

Another object of the present invention is to provide an electronic multilingual business information database system and method, wherein the surrogate IDs are selectively converted into the characters of the business information in different languages in responsive to the language databases. In other words, the search result can be selected in different languages through the conversion of the surrogate ID.

Another object of the present invention is to provide an electronic multilingual business information database system and method, wherein the language database is a dictionary and encyclopedia in responsive to the language thereof, such that when the search result is generated, all the characters can be converted to any language.

Another object of the present invention is to provide an electronic multilingual business information database system and method, wherein the user is able to send the search request in one language and receive the search result in another language so as to eliminate irrelevant information which may have been generated upon translation of the search request by the conventional search engine.

Another object of the present invention is to an electronic multilingual business information database system and method, which is easy and convenient to use, interactive and accurate.

Accordingly, in order to accomplish the above objects, the present invention provides an electronic multilingual business information database system, comprising a business info center, a language info center and a search interaction platform.

The business info center comprises a business database storing a plurality of business information, wherein each of the business information is decomposed into one or more characters in different languages, wherein the business info center storing a plurality of different surrogate IDs, each of which is assigned to represent the characters having the same meaning in different languages.

The language info center comprises a plurality of language databases storing the characters in different languages respectively, wherein the surrogate IDs are linked to the different language databases.

The search interaction platform is communicatively linked with the business info center, wherein when a search request is sent to the business info center, the business info center sorts out the surrogate IDs to match with the search request to generate a search result in a selected language, wherein the surrogate IDs are converted to the respective characters from the respective language database in responsive to the selected language, such that the business information in the selected language is sorted in the search result.

The present invention further provides an electronic multilingual business information search method, comprising the steps of:

(a) providing a business database storing a plurality of business information each of which is decomposed into one or more characters in different languages;

(b) providing a plurality of language databases storing the characters in different languages respectively;

(c) generating a plurality of different surrogate IDs each of which is assigned to represent the characters having the same meaning in different languages, wherein the surrogate IDs are linked to the different language databases;

(d) receiving a search request; and

(e) generating a search result in responsive to the search request by sorting out the surrogate IDs and converting the surrogate IDs sorted out to the respective characters of a selected language from the respective language database.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an electronic multilingual business information database system according to a preferred embodiment of the present invention.

FIG. 2 is a flow diagram of the electronic multilingual business information database search method according to the above preferred embodiment of the present invention.

FIG. 3 illustrates an example of the search of the electronic multilingual business information database system according to the above preferred embodiment of the present invention.

### DETAILED DESCRIPTION OF THE PREFERRED EMBODIMENT

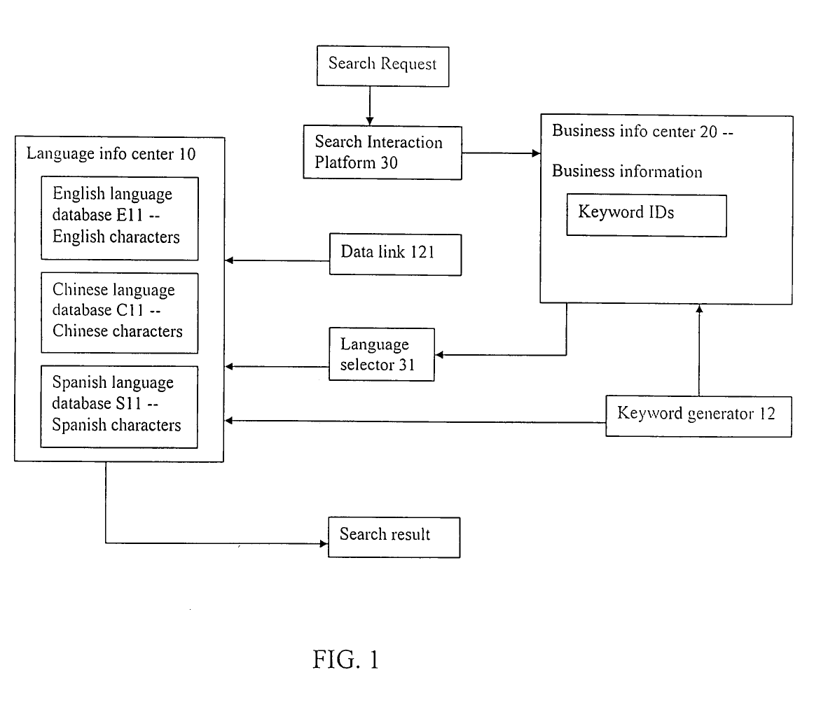

Referring to FIG. 1 of the drawings, an electronic multilingual business information database system is illustrated, wherein the system comprises a language info center 10, a business info center 20, and a search interaction platform 30.

The language info center 10 comprises one or more language databases 11 for storing a plurality of characters in different languages. A surrogate ID generator 12 generates a plurality of different surrogate IDs.

The business info center 20 comprises a business database 21 for storing the business information and the surrogate IDs, wherein each of the business information is decomposed into one or more of the characters in different languages and each of the different surrogate IDs is assigned to represent the characters having the same meaning and expression in different languages. Accordingly, the surrogate IDs are generated in form of surrogate words selected from a group consisting of numbers, alphabets and symbols.

The search interaction platform 30 is communicatively linking with the business info center 20, wherein the user is able to access the search interaction platform 30 through a public communication network such as internet to send a search request to the business info center 20. When the search request is sent to the business info center 20, the business info center 20 sorts out the surrogate IDs to match with the search request to generate a search result in a selected language, wherein the surrogate IDs are converted to the respective characters from the respective language database 11 in responsive to the selected language, such that the business information in the selected language is sorted in the search result.

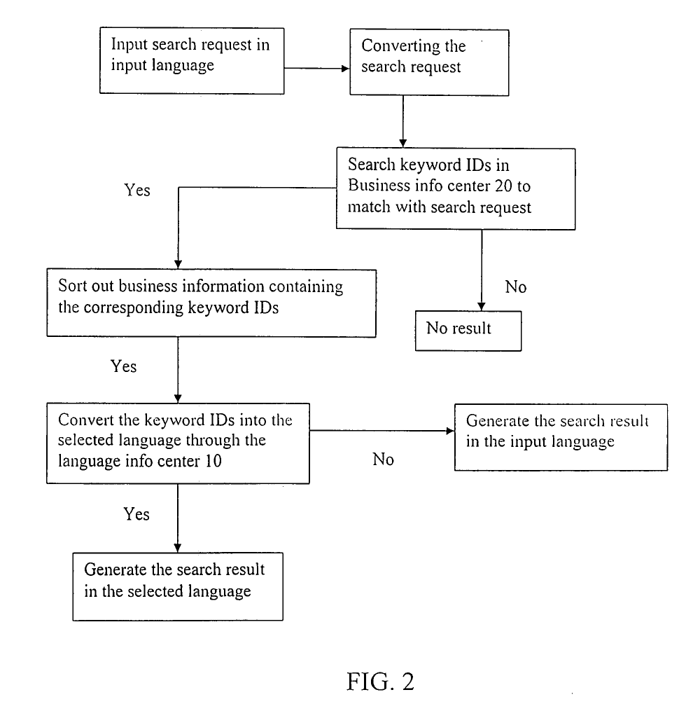

As shown in FIG. 2, the present invention also provides an electronic multilingual business information search method, comprising the following steps.

(1) Provide the business database 21 storing the plurality of business information each of which is decomposed into one or more of the characters in different languages.

(2) Provide the language databases 11 storing the plurality of characters in different languages respectively.

(3) Generate the plurality of different surrogate IDs each of which is assigned to represent the characters having the same meaning and expression in different languages, wherein the surrogate IDs are linked to the different language databases.

(4) Receive the search request in an input language, wherein the search request is converted into the surrogate IDs.

(5) Generate the search result in responsive to the search request, wherein the surrogate IDs are sorted out and converted to the respective characters, such that the business information in a selected language is sorted in the search result.

According to the preferred embodiment, the language database 11 is arranged to store the characters in different languages. In particularly, each of the characters is also assigned with a language ID to denote the character in a particular language. For example, the language ID “E” is assigned for all the characters in English, the language ID “S” is assigned for all the character in Spanish, and the language ID “C” is assigned for all the characters in Chinese. Therefore, when the search request is received, the search interaction platform 30 will determine the input language and will generate the search result in responsive to the language ID. For a particular example, the character “Patent” is assigned to have the numerical representation of “E433” as its surrogate ID with the language ID in English, “S433” as its surrogate ID in Spanish, and “C433” as its surrogate ID in Chinese. It is worth to mention that the language ID can also be generated in form of surrogate words selected from a group consisting of numbers, alphabets and symbols.

Alternatively, the language info center 10 provides a plurality of different language databases 11, wherein each of the language databases 11 is arranged to store the characters in a particular language. For example, the English language database E11 is arranged to store all the characters in English, the Spanish language database S11 is arranged to store all the characters in Spanish, and the Chinese language database C11 is arranged to store all the characters in Chinese. In particularly, using the word “Patent” as an example, “Patent” in English is stored in the English language database E11, “Patente” in Spanish is stored in the Spanish language database S11, and [symbol] in Chinese is stored in the Chinese language database. All the characters, “Patent”, “Patente”, and [symbol] have the same meaning.

Accordingly, each of the language databases 11 is a dictionary and encyclopedia in responsive to the language thereof, such that all the characters in the respective language should be included in the corresponding language database 11. It is worth to mention that the size of each of the language databases 11 is relatively small because each of the language databases 11 is only arranged to store all the related characters.

The surrogate ID generator 12 is a word processor to assign the surrogate ID for each of the characters as shown in the step (2). Accordingly, each of the characters represents one or more words as a phrase to form a part of the business information in responsive to the step (1). For example, “Patent” is considered as one character and a single word, wherein the corresponding surrogate ID is assigned to the word “Patent”. For another example, “Musical Instrument” is considered as one character and a phrase, wherein the corresponding surrogate ID is also assigned to the phrase “Musical Instrument”.

In addition, each of the characters may be assigned with one or more surrogate IDs if necessary. When the character has different meanings, different surrogate IDs are assigned to denote the different meanings of the characters. For example, the character “Firm” has three different meanings of “hard”, “secure”, and “company”. Therefore, three different surrogate IDs are assigned correspondingly. On the other hand, the corresponding surrogate IDs are also denoted the same meanings of “hard”, “secure”, and “company” in different languages. Therefore, when the search request is received as “Law Firm”, the corresponding surrogate ID of “Firm” in responsive to the meaning of company is determined. Likewise, when the search request is received as “Firm Exercise”, the corresponding surrogate ID of “Firm” in responsive to the closest meaning thereof is determined.

The surrogate ID generator 12 will also generate a new surrogate ID for a new character. In other words, when the language database 11 does not contain the new character, the surrogate ID generator 12 will assign the new surrogate ID for the new character. For example, the business information contains an entity name of “Inno Tech Company”, wherein the character of “Inno” is not in the language database 11, such that the surrogate ID generator 12 will generate a new surrogate ID for the character “Inno”.

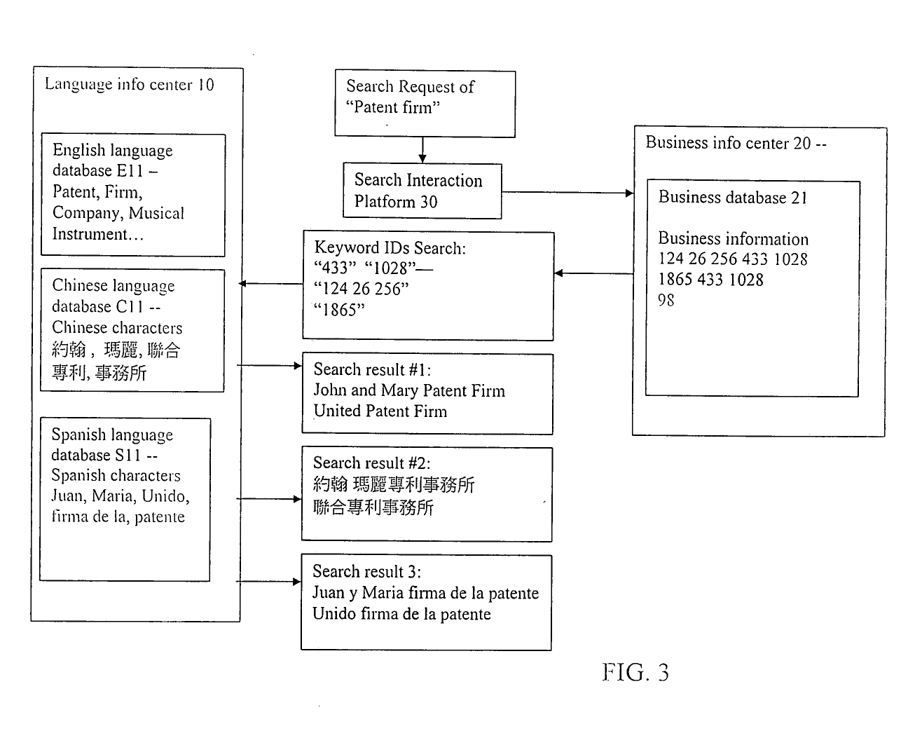

According to the preferred embodiment, each of the surrogate IDs is generated in form of numerical representation as an example. As shown in FIG. 3, the character “Patent” is assigned to have the numerical representation of “433” as its surrogate ID. The character “Firm” is assigned to have the numerical representation of “1028” as its surrogate ID. The character “Musical Instrument” is assigned to have the numerical representation of “98” as its surrogate ID. In other words, each of the characters has its own unique surrogate ID.

As it is mentioned above, each of the business information is decomposed into one or more of the characters and is represented by the surrogate IDs to be stored in the business database 21. Accordingly, each of the business information contains the characters to represent an entity name and a description thereof, as in the step (3), wherein the entity name and the description thereof are edited in form of the surrogate IDs respectively and are stored in the business database 21. For example, the business information is shown as “John and Mary Patent Firm” and “United Patent Firm”, wherein the descriptions thereof are the corresponding addresses respectively. The business database will store the surrogate IDs of “124 26 256 433 1028” for “John and Mary Patent Firm” and the surrogate IDs of “1865 433 1028” for “United Patent Firm”. In other words, the business database will only store the surrogate IDs instead of the words or phrases in a particular language.

The above example also illustrates the common surrogate IDs of “Patent” and “Firm”. Accordingly, the common surrogate IDs are very useful for speeding up the searching process. The business info center 20 will organize all the business information in the business database 21 that the business information with the same categorization are grouped and assigned with the common surrogate IDs, such that the size of the business database 21 will be further minimized and the searching process of the business database will be further simplified. For example, all the patent firms are grouped in the same categorization with the common surrogate IDs of “433 1028”.

In addition, the surrogate ID generator 12 comprises a data link 121 selectively revising the surrogate ID in responsive to the character so as to precisely represent the character in a meaningful manner. For example, two individual characters “Ice” and “Cream” have their own meanings, wherein the data link 121 will revise the character “Ice cream” as a phrase in order to assign a surrogate ID for the phrase “Ice cream”. The data link 121 also allows the user who is authorized by the registered merchant to correct the characters of the business information.

It is worth to mention that the data link 121 will also revise the spelling of the search request, wherein the data link 121 will automatically correct the misspelled character of the search request before the character of the search request is converted into the surrogate IDs for searching.

Accordingly, in order to store the business information in the present invention, the merchant should register to the system of the present invention as the registered merchant. Therefore, the business information can be updated frequently. In addition, the merchant is able to select which language of the business information to be displayed at the search result. For example, the merchant is able to select the business information is sorted out only in English and Chinese such that the search result will only generated to include the business information based on English and Chinese.

When the user inputs the search request, the business info center 20 will sort out the surrogate ID to match with the search request. Accordingly, the search request will converted into the surrogate IDs to match with the surrogate IDs in the business info center 20. For example, when the “patent firm” as the search request is sent, the business info center 20 will sort out the surrogate ID to match with “patent firm”. As it is illustrated above, the surrogate IDs of “124 26 256 433 1028” and the surrogate IDs of “1865 433 1028” are found in the business database 21 in responsive to the surrogate IDs of “patent firm”. Accordingly, the business info center 20 will also sort out the surrogate IDs which are similar to the search request. For example, when the search request of “patent firm” is sent, the business info center 20 will also sort out the surrogate ID to match with “patent company”, “patent corporation”, “patent association”, and so on. When the search request of “patent form” is sent, the business info center 20 will refine the search request to “patent firm”, “patent company”, “patent corporation”, “patent association”, and so on.

Therefore, the next step of the system will determine which language should be displayed in the search result. As shown in FIG. 1, the search interaction platform 30 comprises a language selector 31 communicatively linked to the language info center 10 to link the surrogate IDs in the selected language, before the step (5), such that when the search request is received in the input language which is different from the selected language, the search result is automatically generated in the selected language. For example, when the user inputs the search request in English and selects the search result in Chinese, the Chinese language database C11 is automatically linked to sort out the Chinese characters in responsive to the surrogate IDs. It is worth to mention that no matter which language of the search request is input by the user, the business info center 20 will only sort out the surrogate IDs in the business database 21. If the user does not select any language for the search result, the input language of the search request is set as the selected language of the search result. In other words, when the user inputs the search request in English without specifically selecting any selected language, the English language database E11 is automatically linked to sort out the English characters in responsive to the surrogate IDs. In addition, after the search result is generated, a language option is shown for the user to select other available languages. Therefore, the user is able to select the search result in other languages or all available languages.

When the search result is generated, the surrogate IDs are correspondingly converted into the characters to output the entity name and the description thereof in the search result. According to the preferred embodiment, when the user selects English for the search result, the surrogate IDs of “124 26 256 433 1028” are converted to “John and Mary Patent Firm” and the surrogate IDs of “1865 433 1028” are converted to “United Patent Firm”. Therefore, the search result will contain “John and Mary Patent Firm” and “United Patent Firm” in English in responsive to the search request of “patent firm”. Thereafter, if the user wants to switch the search result from English to Chinese, the business info center 20 will link to the Chinese language database. Therefore, the surrogate IDs of “124 26 256 433 1028” and the surrogate IDs of “1865 433 1028” are converted to [symbol] [symbol] and [symbol] correspondingly. When the user selects the search result in Spanish, the search result will contain “Juan y Maria firma de la patente” and “Unido firma de la patente”. It is worth to mention that no translation is involved through the searching process.

Accordingly, when the language info center 10 comprises seven different language databases 11, including English, Spanish, Chinese, German, French, Italian, and Japanese, the user is able to input the search request with any one of languages and to select one or more different languages for the search result. Each of the language databases 11 will only contains the corresponding characters, such as English characters, Spanish characters, Chinese characters, German characters, French characters, Italian characters, and Japanese characters, so that the size of each of the language databases 11 is relatively small. Thus, the business info center 20 will only contain the surrogate IDs in the business database 21, in which the common surrogate IDs are used as the common characters in different languages. Therefore, the size of the business database 21 is relatively small and the searching process through the business database 21 is relatively effective. In other words, the searching time of the business info center 20 is relatively short because of the surrogate IDs. The conversion time of the surrogate ID is relatively short to convert the surrogate ID into a particular character in the selected language.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An electronic multilingual business information database system, comprising a search interaction platform communicatively linking to a plurality of business information, wherein each of said business information is decomposed into one or more characters in different languages and is denoted by one or more different surrogate IDs, wherein each of said different surrogate IDs is assigned to represent said characters having the same meaning and expression in different languages, wherein when a search request is received, said search request is converted into said surrogate IDs to match with said surrogate IDs of said business information to generate a search result in a selected language, wherein said surrogate IDs of said business information are converted to said respective characters in responsive to said selected language, such that said corresponding business information in said selected language is sorted in said search result.

2. The electronic multilingual business information database system, as recited in claim 1, further comprising a business info center which comprises a business database storing said business information and said surrogate IDs, and a language info center which comprises one or more language databases storing said characters in different languages to link with said surrogate IDs, wherein said business info center sorts out said surrogate IDs of said business information to match with said search request to generate said search result, and then said surrogate IDs are converted to said respective characters from said language database in responsive to said selected language.

3. The electronic multilingual business information database system, as recited in claim 1, wherein each of said characters represents one or more words as a phrase to form a part of said business information.

4. The electronic multilingual business information database system, as recited in claim 2, wherein each of said characters represents one or more words as a phrase to form a part of said business information.

5. The electronic multilingual business information database system, as recited in claim 1, further comprising a surrogate ID generator generating said surrogate IDs in form of surrogate words selected from a group consisting of numbers, alphabets and symbols.

6. The electronic multilingual business information database system, as recited in claim 4, further comprising a surrogate ID generator generating said surrogate IDs in form of surrogate words selected from a group consisting of numbers, alphabets and symbols.

7. The electronic multilingual business information database system, as recited in claim 2, wherein each of said business information contains said characters to represent an entity name and a description thereof, wherein said entity name and said description are edited in form of said surrogate IDs respectively and are stored in said business database, such that when said search result is generated, said surrogate IDs are correspondingly converted into said characters correspondingly to output said entity name and said description in said search result.

8. The electronic multilingual business information database system, as recited in claim 6, wherein each of said business information contains said characters to represent an entity name and a description thereof, wherein said entity name and said description are edited in form of said surrogate IDs respectively and are stored in said business database, such that when said search result is generated, said surrogate IDs are correspondingly converted into said characters correspondingly to output said entity name and said description in said search result.

9. The electronic multilingual business information database system, as recited in claim 1, wherein said search interaction platform comprises a language selector communicatively linked to said surrogate IDs in said selected language, such that when said search request is received in an input language which is different from said selected language, said search result is automatically generated in said selected language.

10. The electronic multilingual business information database system, as recited in claim 6, wherein said search interaction platform comprises a language selector communicatively linked to said language info center to link said surrogate IDs in said selected language, such that when said search request is received in an input language which is different from said selected language, said search result is automatically generated in said selected language.

11. The electronic multilingual business information database system, as recited in claim 8, wherein said search interaction platform comprises a language selector communicatively linked to said language info center to link said surrogate IDs in said selected language, such that when said search request is received in an input language which is different from said selected language, said search result is automatically generated in said selected language.

12. The electronic multilingual business information database system, as recited in claim 6, wherein said surrogate ID generator comprises a data link selectively revising said surrogate ID in responsive to said character so as to precisely represent said character in a meaningful manner.

13. The electronic multilingual business information database system, as recited in claim 11, wherein said surrogate ID generator comprises a data link selectively revising said surrogate ID in responsive to said character so as to precisely represent said character in a meaningful manner.

14. An electronic multilingual business information search method, comprising the steps of:
(a) decomposing each of business information into one or more characters in one or more different languages;
(b) generating a plurality of different surrogate IDs each of which is assigned to represent said characters having the same meaning and expression in different languages;
(c) receiving a search request, wherein said search request is converted into said surrogate IDs; and
(d) generating a search result in responsive to said search request by sorting out said surrogate IDs of said business information being matched with said surrogate IDs of said search request and converting said surrogate IDs of said business information to said respective characters of a selected language.

15. The method as recited in claim 13 wherein, in the step (a), each of said characters represents one or more words as a phrase to form a part of said business information.

16. The method as recited in claim 14 wherein, in the step (b), each of said surrogate IDs is generated in form of surrogate words selected from a group consisting of numbers, alphabets and symbols.

17. The method as recited in claim 15 wherein, in the step (b), each of said surrogate IDs is generated in form of surrogate words selected from a group consisting of numbers, alphabets and symbols.

18. The method as recited in claim 14 wherein each of said business information contains said characters to represent an entity name and a description thereof, wherein said entity name and said description are edited in form of said surrogate IDs respectively and are stored in a business database, such that when said search result is generated, said surrogate IDs of said business information are correspondingly converted into said characters correspondingly to output said entity name and said description in said search result.

19. The method as recited in claim 17 wherein each of said business information contains said characters to represent an entity name and a description thereof, wherein said entity name and said description are edited in form of said surrogate IDs respectively and are stored in a business database, such that when said search result is generated, said surrogate IDs of said business information are correspondingly converted into said characters correspondingly to output said entity name and said description in said search result.

20. The method, as recited in claim 14, before the step (d), further comprising a step of selecting said selected language of said search result, wherein said surrogate IDs are converted to said characters in responsive to said selected language.

21. The method, as recited in claim 19, before the step (d), further comprising a step of selecting said selected language of said search result, wherein said surrogate IDs are converted to said characters in responsive to said selected language.

22. The method as recited in claim 14 wherein, in the step (d), said search request is inputted in an input language which is set as said selected language of said search result.

23. The method as recited in claim 19 wherein, in the step (d), said search request is inputted in an input language which is set as said selected language of said search result.

24. The method, as recited in claim 14, further comprising a default step of revising said surrogate ID in responsive to said character to precisely represent said character in a meaningful manner.

25. The method, as recited in claim 19, further comprising a default step of revising said surrogate ID in responsive to said character to precisely represent said character in a meaningful manner.
